(19) United States
(12) Patent Application Publication
(10) Pub. No.: US 2009/0178569 A1
(43) Pub. Date: Jul. 16, 2009

(54) Tea brew basket

(76) Inventors: George H. Tucker, N. Lauderdale, FL (US); Denise F. Tucker, N. Lauderdale, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 12/218,099

(22) Filed: Jul. 11, 2008

Related U.S. Application Data
(60) Provisional application No. 60/949,099, filed on Jul. 11, 2007.

(51) Int. Cl. A47J 31/18

(52) U.S. Cl. 99/282; 99/284; 99/281

(57) ABSTRACT

A tea brewing assembly which is disposed within an upper housing of a coffee maker and operates in conjunction with the coffee maker. The coffee maker delivers heated water to tea brewing assembly which includes a tea brewing basket divided into two sections by an internal wall, a tea leaf holder and a cover having a tea leaf holder positioner. A controllable valve in the internal wall provides communication between the two basket sections at an appropriate water temperature, which permits the heated water to contact the tea leaves in the tea leaf holder. A controller operates a drain valve at the bottom of the brewer basket at an elapsed brew time causing the brewed tea to ultimately enter a conventional pouring carafe. Sensors and operator selections control either the brew time, brew temperature or both for opening the wall and drain valves.

The present application claims priority to and the benefit of U.S. Application Ser. No. 60/949,099, filed Jul. 11, 2007 which is incorporated by reference in its entirety.

### FIELD OF THE INVENTION

The present invention relates to a tea brewer basket in combination with a coffee maker.

### BACKGROUND OF THE INVENTION

Many persons own and use a coffee maker which generally includes a vertical superstructure, an overhanging sub-structure extending therefrom and a basket which hangs from the vertical superstructure (or sometimes hangs from the extending overhanging sub-structure). The basket typically holds ground coffee beans. As is known, this common coffee maker includes a water reservoir, a heater for the water and a removable carafe which rests during the brewing operation beneath the overhanging sub-structure. Heated water is fed through appropriate conduits or transfer channels to the overhanging sub-structure and is channeled into the basket which retains the ground coffee beans. The beans brew in the heated water and coffee is ejected or flows from the lower end of the brew basket into the carafe disposed beneath the basket.

Due to the wide availability of these coffee makers and the growing popularity of hot tea (and sometimes cold tea), it is beneficial to provide a brewing system for tea which may be supplemental to the common coffee maker.

### OBJECTS OF THE INVENTION

It is an object of the present invention to provide a tea brew system which operates in conjunction with a common coffee maker.

It is a further object of the present invention to provide a tea brewing system which is a singular unit configured as a tea brewer basket which replaces the common coffee bean retaining basket in the common coffee maker.

It is another object of the present invention to provide a tea brewing system with controls for brew time, in one instance, and in another instance, brewing temperature and, in a third instance, both brew time and brewing temperature.

It is still another object of the present invention to provide a tea brewing system which permits selection of a specific brewing time which corresponds to the type of tea being brewed, such as, but not limited to, green tea, black tea, and oblong tea.

### SUMMARY OF THE INVENTION

The tea brew basket operates in conjunction with a coffee maker. The coffee maker includes a vertical superstructure and an overhanging sub-structure which delivers heated water through the sub-structure into a carafe located beneath the sub-structure. Other coffee makers and devices which can also deliver the required heated water can also be used and are considered within the scope of the invention. The coffee maker also includes a carafe for receiving the brewed coffee and an outer member disposed the carafe for holding a coffee filter assembly.

With the conventional coffee filter assembly removed, the present invention provides a tea brewing system or assembly in its place (i.e. is disposed within the outer member of the coffee maker above the carafe). In a preferred embodiment, the present invention tea brewing system includes a tea leave basket or holder, a primary brewing basket, a brewing basket cover/positioner and a controller having appropriate circuitry/electronics for controlling the valves, water volumes, water temperature thresholds, brewing time thresholds, tea type selections, etc. The tea leaves are disposed and retained within the tea holder. In the preferred embodiment, the basket cover is provided with a downwardly extending positioned member for receiving the tea leave filled tea holder and properly positioning the tea holder within the brewing basket. The primary brewing basket is preferably sectioned or divided by a wall member having a valve member disposed therein. Placement of the cover on the primary brewing basket causes the downwardly extending positioner to dispose the tea holder within a hydraulically isolated chamber or section of the brewing basket which isolated chamber is divided away from and isolated from the remaining section/area of the brewing basket by the wall member. The control circuitry is used to select the type of tea to be brewed, which determines the proper water temperature and brew time.

In use, water conventionally heated by the coffee maker enters into the water receiving area/section of the brewing basket, which is hydraulically isolated from the area of the basket housing the tea holder. Once the temperature of the water reaches the desired temperature for the type of tea disposed within the tea holder, a valve or other mechanism is opened to create an opening within the wall member to permit the heated water to enter the previously isolated area of the brewing basket containing the tea holder. The heated water contacts the tea leaves and is allowed to brew for a preferably predetermined amount of time. A controller operates a controllable valve at the bottom of the brewing basket to permit the brewed tea to exit the brewing basket and drop into outer member of the coffee maker and ultimately into the carafe disposed underneath, which can be a conventional carafe used with a coffee maker. The controller uses sensors and operator selectable control input to control either the brew time, brew temperature or both prior to opening the valve at the bottom of the brewer basket.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates generally a common coffee maker which can be used in connection with the tea brewing assembly of the present invention to brew one or more types of hot tea;

FIG. 2 diagrammatically illustrates a perspective exploded view of a tea brewing assembly in accordance with the present invention;

FIG. 3 diagrammatically illustrates a perspective partially exploded view of the tea brewing assembly of FIG. 2;

FIG. 4 diagrammatically illustrates a perspective view of the tea brewing assembly of FIG. 2 fully assembled;

FIG. 5 diagrammatically illustrates a perspective view of the assembled tea brewing assembly being disposed within an outer member of a common coffee maker;

FIG. 6 diagrammatically illustrates a schematic of the tea brewing system/assembly and particularly the electronic controls therefor in accordance with the present invention; and

FIG. 7 diagrammatically illustrates a flow chart showing the operation of the controller of the tea brewing assembly in accordance with the present invention.

### DETAILED DESCRIPTION OF THE PREFERRED EMBODIMENTS

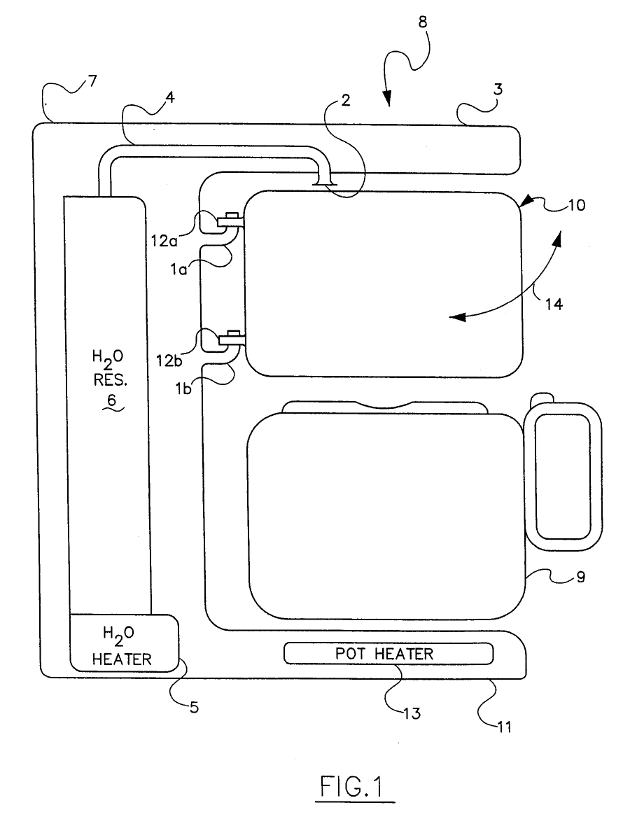

The present invention relates to tea brewing basket assembly or system which is used in combination with a conventional or common coffee maker, with the tea brewing basket generally referenced as assembly 19. FIG. 1 diagrammatically illustrates generally a conventional coffee maker having an upper housing member 10 hanging on or otherwise secured to a portion of a common coffee maker 8. When brewing coffee, a coffee filter assembly is normally disposed and housed within upper housing member 10. When brewing tea with the present invention, the conventional coffee filter assembly is removed and tea brewing assembly 19 is disposed and housed within upper housing member 10.

As disclosed in more detail in our U.S. Pat. No. 6,964,222, which is incorporated by referenced in its entirety, coffee maker 8 can include a vertical superstructure 7, a water reservoir 6 and a water heater 5. As is known, water heater 5 heats the water in water reservoir 6 and the heated water is fed via a conduit, channel or passage 4 to an overhanging sub-structure 3. Upper housing member 10 can be secured to coffee maker by any conventional manner and all are considered within the scope of the invention. In addition, common coffee maker 8 includes a carafe 9 which retains either brewed coffee or tea (tea when in use with the present invention) and is kept warm by a pot heater. In the illustrated embodiment, common coffee maker 8 includes a base 11 within which pot heater 13 is located. Carafe 9 can also be provided with thermos capabilities to permit the fluid (coffee, tea, etc.) disposed within to retain its heat for several hours, which can eliminate the need for a pot heater component with coffee maker 8. The present invention is not considered limited to any specific coffee maker and various coffee makers can be used with the present invention tea brewing assembly/system 19.

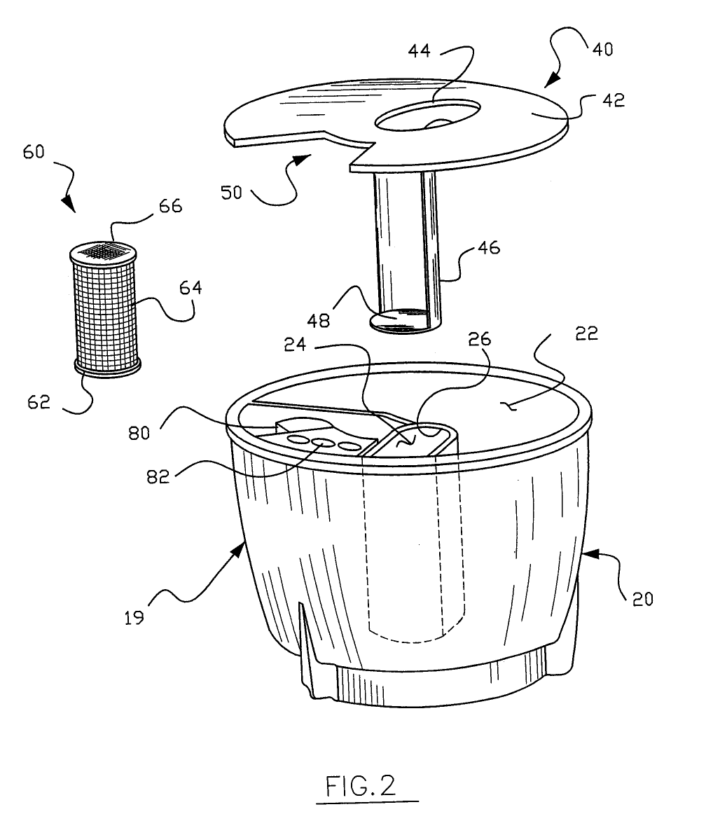

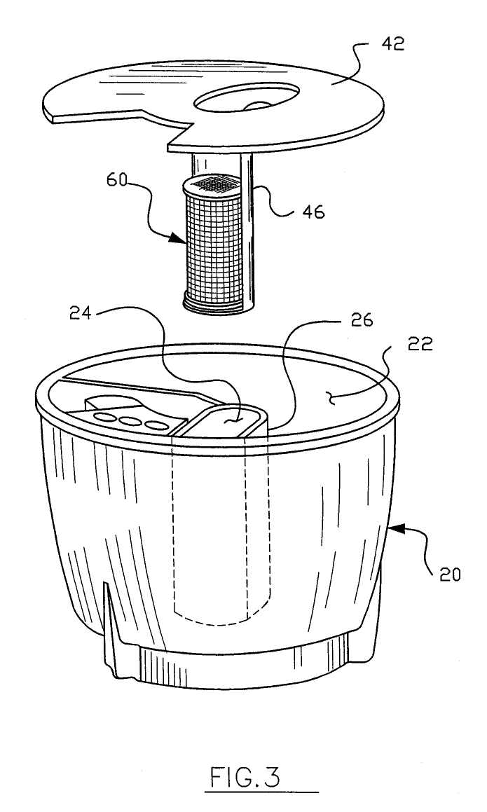

As best seen in FIG. 2 and FIG. 3, tea brewing assembly 19 of the present invention generally includes a tea leaf holder 60, a primary brewing basket 20, a brewing basket cover/positioner 40 and a controller 80 having appropriate circuitry/electronics/display for controlling the valves, water volumes, water temperature thresholds, brewing time thresholds, tea type selections, etc.

The tea leaves are disposed and retained within tea holder 60. Though not required, holder 60 can be cylindrical in shape and is provided with a bottom portion 62 and a movable top portion 66 which can be hinged or otherwise movably secured to an intermediate portion 64. Intermediate portion 64 can be constructed from a screen, mesh, screen-like or mesh-like material which provides a plurality of openings in holder 60 for heated water to enter 60 and make contact with the tea leaves retained therein. Other non-dissolvable materials, which will provide the desired rigidity and openings, can also be used for intermediate portion 64 of tea holder 60. Top lid or portion 66 can be moved or swung from an open to a closed position to permit the user to load cut or loose tea leaves into the interior of tea leaf holder 60 defined by bottom portion 62, intermediate portion 64 and top portion 66. After the tea leaves are loaded into the interior of tea leaf holder 60, top portion/lid 66 can be retained closed by any suitable locking mechanism. As described above and below, intermediate portion 64 of tea leaf holder 60 can include one or more screen or mesh areas (i.e. openings), which permit the tea leaves retained within holder 60 to interact with the properly heated water entering into chamber 24 from chamber 22.

Primary brewing basket 20 is preferably sectioned or divided by a wall member 26 having a valve or other opening/closing mechanism disposed therein. Proper placement of cover portion 42 on the upper ledge/edge of primary brewing basket 20 causes a downwardly extending positioner 46 to place tea holder 60 within a hydraulically isolated chamber or section 24 of brewing basket 20 which is divided and isolated from the heated water receiving section/area 22 of the brewing basket by wall 26. Tea holder 60 rests on bottom surface of 48 of positioner 46. Positioner 46 can be preferably shaped to correspond to the shape of tea holder 60, such that it partially surrounds tea holder 60. Though not considered limiting, controller 80 is preferably located within section 24 of brewing basket, with control or selection keypad or buttons 82 disposed at the top of section 24. Amongst other things, controller 80 is used to select the type of tea to be brewed, which determines the proper water temperature and brew time.

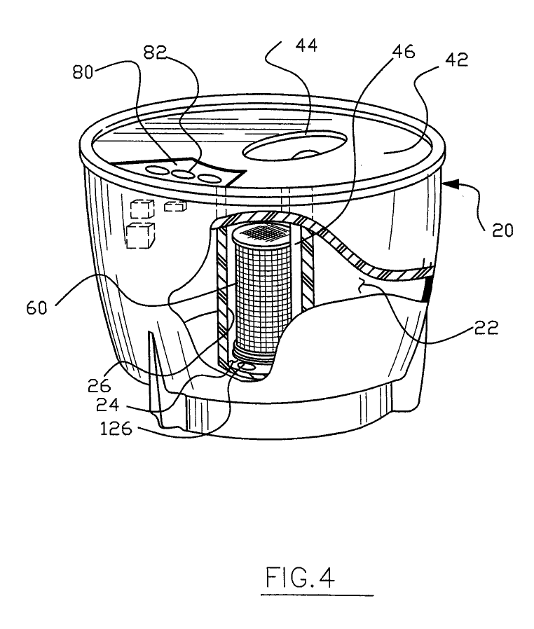

In use, water conventionally heated by coffee maker 8 exits a water port 2 of coffee maker 8 for entry into water receiving area/section 22 of brewing basket 20, which is hydraulically isolated from area 24 by wall 26. Thus, the water is isolated from tea holder 60 disposed within area 24 by positioner 46. Once the temperature of the water in area 22 reaches the desired temperature for the type of tea disposed within tea holder 60, a valve or other mechanism in wall 26 (preferably near the bottom of wall 26) is opened to create an opening within wall 26 which permits the heated water to enter the previously isolated area 24 of brewing basket 20 that contains tea holder 60. The heated water contacts the tea leaves disposed within holder 60 and is allowed to brew for a preferably predetermined amount of time. When such time has elapsed, controller 80 operates one or more controllable valves at the bottom of brewing basket 20 to permit the brewed tea to exit the brewing basket and drop into upper housing member 10 of coffee maker 8 and ultimately into carafe 9 disposed underneath. As described in more detail below, controller 80 uses sensors and operator selectable control input to control either the brew time, brew temperature or both prior to opening the valves in wall 26 and at the bottom of brewer basket 20.

Where cover portion 42 completely covers basket 20 (See FIG. 4), an opening 44 in cover portion 42 can be provided and is preferably aligned with port 2 to permit access to receiving area 22 for the heated water exiting port 2. Though not shown, cover portion is not required to cover the entire basket 20, and in an alternative embodiment, can cover hydraulically isolated portion 24, with port 2 positioned over heated water receiving area 22. In either cover embodiment, downwardly extending positioner 46 receives the tea leave filled tea holder 60 and properly positions tea holder 60 within isolated section 24 of brewing basket 20. Positioner 46 can also be considered a carrier for tea leaf holder 60. Also in either cover embodiment, a cutout 50 can be defined in cover 42 which is preferably shaped to correspond to the shape of controller 80. Thus, when placing cover 42 on the ledge of basket 20, aligning cutout 50 with controller 80 guarantees that positioner 46 (and tea holder 60) will properly be located within isolated portion 24 such that tea holder will not contact the water initially provided to area 22, until it is determined that such water has been heated to the proper temperature for the type of tea selected by the user using controller 80.

Similar to a conventional coffee filter assembly, tea brewing assembly 19 is removable from upper housing member 10 of coffee maker 8.

Similar numerals designate similar items throughout the figures.

Controller or control-display unit 80 can be similar in construction and/or operation to the controller/control-display unit described in our U.S. Pat. No. 6,964,222. Unit 80 can be both a control and a user display. In general, heated water is retained in interior chamber/area 22 of tea brewer basket 20, until an internally located sensor informs controller 80 that the water temperature has reached the required level, causing the controller to send a signal or command to open a valve in wall 26 or otherwise create an opening in wall 26 to permit water to flow into area 24 of basket 20. The contact of the heated water with the tea leaves in holder 60 permits the tea leaves to brew or stew in the heated water. Control-display 80 accepts input from various sensors (described later) and can also monitor water height and temperature such that at the appropriate time and/or temperature, one or more valves 134 at the lower end of basket 20 is (are) opened such as under the control of an actuator 136 and the brewed tea is released via a lower port or opening in the bottom of basket 20 into upper housing member 10 and ultimately into carafe 9. A switch can also be optionally provided to determine the presence or absence of carafe 9.

Control-display 80 can also accepts input from various sensors such as an optional high water sensor 142, an optional low or minimum water sensor 144 and a temperature sensor 146. If the temperature of the water in interior region 22 is too high, control-display 80 can open an air vent 148 (where cover 42 also covers the water receiving area 22) permitting the water in area 22 to cool until an appropriate temperature is sensed by temperature sensor 146. The particular location of the various sensors, valves, actuators, air vent, etc. within basket 20 is not considered limited to any particular location and any location which will permit such components to operate and function correctly can be selected and are considered within the scope of the invention.

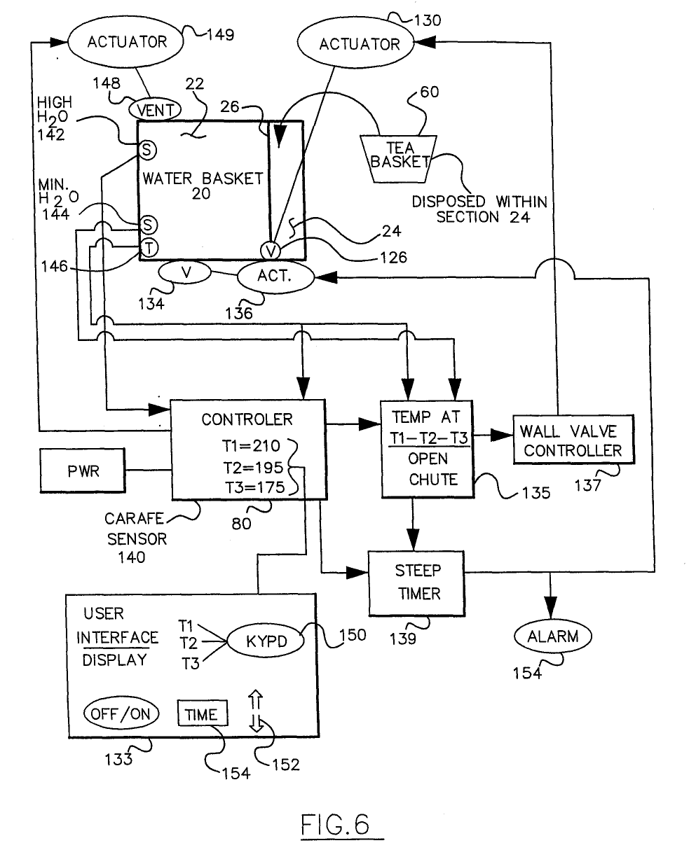

The electrical system of the present invention controller 80 works similar to the electrical system described in our U.S. Pat. No. 6,964,222. Controller 80 can receive inputs from high water sensor 142 and a minimum water sensor 144, which again are optional and the present invention can operate with such sensors. Controller 80 can also receive input from a user interface-display 133. In general, FIG. 6 shows functional block units for the control system. User interface-display 133 can include a global or system ON/OFF control and permits the user in the illustrated embodiment to select the type of tea being brewed. For example, green tea is typically brewed at 175 degrees F., Oolong tea is brewed at 195 degrees and black tea or herb tea is brewed at 210 degrees. Typically, hot water from a coffee brewer is fed into the coffee brew basket at 205 degrees F. Controller 80 can also be programmed for brewing white tea and such is also considered within the scope of the invention.

There are three principle issues relating to the brewing of tea. One issue is the temperature at which the tea is brewed. Another issue is the amount of time the tea leaves steep in the hot water. A third issue is that tea leaves typically float. Tea leaf holder 60 can be constructed such that its weight is heavier than water to eliminate the possibility of holder floating in around chamber 24 once the heated water enters chamber 24 when valve 126 in wall 26 is opened. Additionally, though it is preferred to position holder 60 within chamber 24 with positioner 46, positioner 46 can also be eliminated (leaving cover 42) and tea holder 60 can be manually placed within chamber 24. Furthermore, a small protrusion or recess in the bottom surface of chamber 24 can be provided for identifying an exact area in chamber 24 for manually placing tea holder 60, and which will also help to retain holder 60 in position within chamber 24 once the heated water starts to enter through the wall opening. Though not considered limited to any specific length, size, shape or dimensions, tea leaf holder 60 can be somewhat elongated in length and can be at least over half the height of said chamber 24 in length, as well as substantially the height of basket 20. Similarly, positioner 46 can be substantially the height of basket 20 such that when cover 40 is placed on the upper edge of the basket perimeter and/or upper edge of wall 26 (depending on which cover embodiment), base 48 or positioner 46 can be approximate to a bottom surface area of chamber 24. Since the user selects via buttons or keys 82 on keypad 150 either the temperature or the type of tea (controller 80 may identify temperature or the tea selection or both), controller 80 identifies the pre-programmed steep time for each different tea. The steep times, suggested brewing temperatures for each type of tea, etc. are stored in memory. An up or down time arrow 152 can be provided on keypad 150 for increasing or decreasing the steep time and/or brewing temperatures. A time display 154 can also be provided to the user. Arrow 152 can also be used to select tea type (i.e. in conjunction with a scroll menu selector).

Controller 80 determines the temperature of the water within chamber 22 of basket 22 via sensor 146 and the amount of time necessary to brew the tea in the hot water once valve 126 in wall 26 is opened to allow contact between the water and the tea leaves contained within holder 60 disposed in chamber 24 of tea brewing basket 20. Control unit 135 accepts as input an indication of temperature from temperature sensor 146 and preferably can also receive input from a minimum water level sensor 144. Minimum water level sensor 144 provides a minimum water level threshold for area 22 of basket 20 in order to brew the smallest amount of tea. Control unit 135, which accepts a temperature signal from controller 80 (ultimately selected by the user using interface/display 133) determines when (1) the minimum water sensor 144 (when provided) is detecting sufficient water and (2) when temperature sensor 146 meets or exceeds the designated temperature set by controller unit 80. For situations where a large amount of tea is to be brewed, a high water level sensor 142 can be provided. Controller 80 can be set to detect when high water level sensor 142 is ON, that is, to sense the presence of significant or sufficient water in area 22 of brewing basket 20. If the temperature detected by temperature sensor 146 exceeds the designated temperatures T₁ through T₃, control unit 80 can open air vent 148 (when provided) by a command sent to actuator 149. Air vent 148 can be provided where receiving area 22 is covered by cover 42 (See FIG. 4). Air vent 148 simply vents cooler air into area 22 of basket 20 thereby cooling the hot water. When temperature sensor 146 reaches the appropriate temperature (or a designated range about the appropriate temperature), air vent 148 can be closed by activating actuator 149 through a command from control unit 80.

Dependent upon minimum water sensor 144 (when provided) and temperature sensor 146, control unit 135 gives an OPEN CHUTE command to wall valve controller 137. Wall valve controller 137 modifies or conditions the signal from controller units 80 and 135 and activates valve activator 130 to open wall valve 126 (or other open/close mechanism) in wall valve 26 which permits fluid communication between area 22 and area 24 of basket 20 and allowing the heated water to contact the tea leaves contained within tea holder 60. At that time, controller 80, and to some degree controller 135, activates steep timer 139. Steep timer 139 determines when the appropriate time has passed after OPEN CHUTE to steep the tea in the hot water. When the tea is sufficiently steeped, steep timer times out, and an alarm 154 can be turned ON (audio or visual or both) and the steep timer issues a command to valve actuator 136 which opens one or more lower valve(s) 134 in the bottom of tea brewing basket 20. In view of the opening of valve(s) 134, hot tea drains from tea brewing basket 20 temporarily into conventional upper housing member 10 and ultimately into carafe 9. Of course, controller 80 can also accept a control input from a carafe sensor 140 in order to ensure that carafe 9 is beneath tea brewing basket 20.

In a further development of the present invention, if the region in water receiving area 22 is too small for the amount of tea requested by the user, the control system can be modified and the user interface/display can be modified such that a highly concentrated amount of tea is steeped in brewing basket 20, then valve(s) 134 is (are) opened which drains the concentrated tea into carafe 9 while coffee maker 8 continues to pour heated water into the water receiving area 22. In this operational setting, high water sensor 142 operates as an interim control to sense when the water reaches that high level. In other words, high water level sensor 142 is both a safety sensor as well as a control sensor in that when water reaches high water level 142, valve(s) 134 is(are) opened thereby draining basket 20 of concentrated tea. The control parameters in control unit 135 and steep timer 139 would have to be reset in this enhanced operation version of tea brewer system 19.

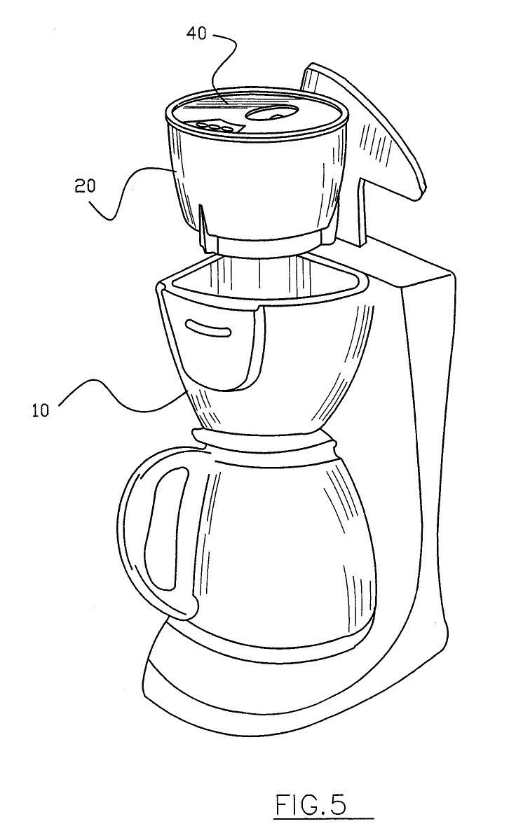

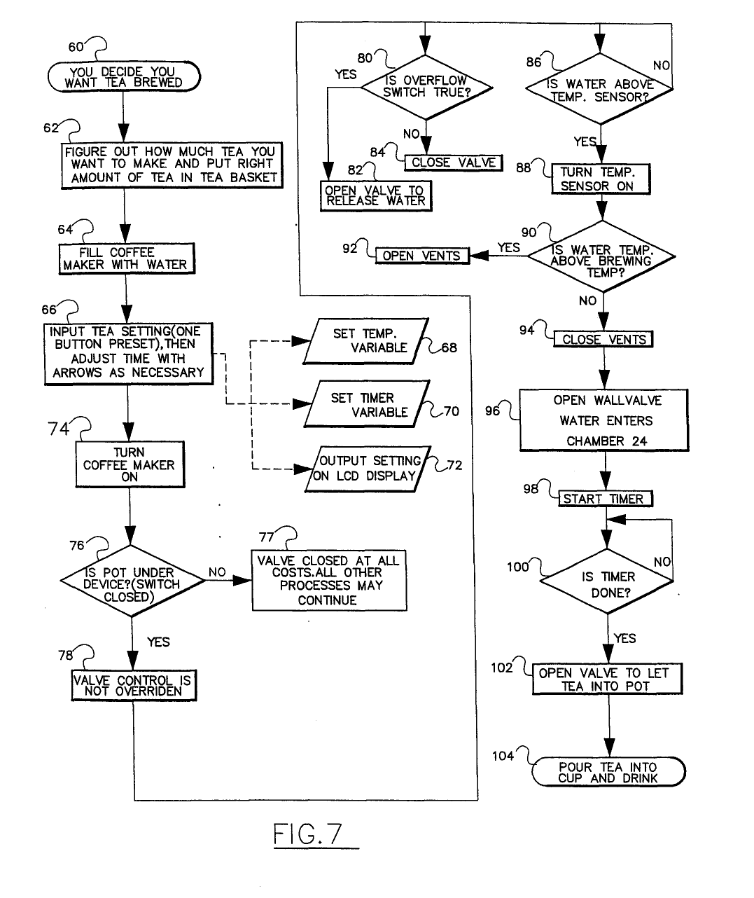

FIG. 7 diagrammatically illustrates a flow chart showing the operation of tea brewer system 19. Step 160 permits the user to decide what type of tea the user would like to brew. Step 162 indicates that the user can select the appropriate amount of tea leaves to be put in tea leaf holder 60. The appropriate amount of tea leaves selected are placed and retained by tea holder 60 which is placed on bottom surface of positioner 46. Cover 40 is positioned on the upper edge or ledge of basket 20 causing tea holder 60 to be disposed within hydraulically chamber 24 of basket 20. Basket 20 is dropped or disposed within upper housing member 10 of coffee maker 8 (See FIG. 5). As also seen in FIG. 5, basket 20 can be positioned with keypad 150/buttons 82 positioned in the front of coffee maker 8 which can also help to align opening 44 (in one cover embodiment) or water receiving area 22 (in another cover embodiment) with the water exit port 2 of coffee maker 8. At this point, assembly 19 in conjunction with coffee maker 8 is ready to brew tea.

Step 164 indicates that the user fills common coffee maker 8 with water. Step 166 indicates that the user selects the type of tea setting either time or type of tea as discussed earlier. The user can also adjust the steep time as discussed above in connection with up and down arrows 152. The controller (a combination of controller unit 80, 135, 137 and 139) sets the temperature in step 168, sets the timer in step 170 and can outputs the appropriate setting indicator on the display unit in step 172. The user interface/display 33 can include a display screen, such as, but not limited to, an LCD screen, which would neatly display the time at one instance and then type of tea at another instance or any other information that assists the user in operating tea brewer system 19.

After step 166, the user turns the coffee maker ON in step 174. In step 176, the controller can determine whether a carafe sensor 140 (when provided) determines the presence of the carafe beneath upper housing member 10. If not, the system branches via the NO branch to step 177 which issues a control command to assure that valve(s) 134 is(are) closed. If the YES is taken from step 176, step 178 does not override the valve control sub-system. After step 178, the system can enter decision step 180 which determines whether the overflow or high water switch or sensor 142 (if provided) is TRUE or senses the presence of high water in water receiving area 22 of basket 20. If YES, the system executes step 182 which opens valve(s) 134 to release water in water basket receiving area 22. If NO, step 184 again issues a command to CLOSE lower valve(s) 134 in the tea brew basket system 19. Concurrent with decision step 180 (overflow switch TRUE), the system activates decision step 186 which determines whether the water is above the low water or minimum water level based upon the output of sensor 144. If NO, the program repeats to execute decision steps 180, 186. If YES, the system in step 188 turns the temperature sensor 146 ON. In step 190, a decision is made whether the water temperature is above the brewing temperature. The brewing time and/or temperature can be selected by the user or by the pre-programmed routine in steps 166, 168, 170 and 172. If YES, the program executes step 192 which opens air vent 148 to cool the water in water receiving area 22. If NO, the system in step 194 closes vent 48 by triggering actuator 49. In step 196, the wall valve 126 in wall 26 is opened permitting appropriately heated water from receiving area 22 to enter into area 24 and contact tea leaf holder 60. In step 198, the brew timer is activated which monitors the steeping time of the tea leaves in the hot water retained by basket 20. Decision step 200 determines whether the brew timer has timed out. If YES, step 202 opens valve(s) 134 and dispenses the brewed tea temporarily into upper housing member 10 and ultimately into carafe 9. Step 204 can relate to the user utilizing carafe 9 to pour tea into a tea cup. If the timer in decision step 200 has not timed out, the system can loop to a point immediately preceding decision step 200. It should be recognized that the present invention system can operate without the high water sensor, and the low water sensor, and a system not having one or both of these sensors is also considered within the scope of the invention. Additionally, even when cover 40 covers the entire internal area of basket 20, opening 44 in cover 40 can also serve as a vent and thus can eliminate the need for a separate vent assembly, such as vent 148 and actuator 149.

It is important to note that the electrical system discussed in FIG. 6 identifies functional elements and many of these elements can be combined into one or more integrated circuits or specially configured circuitry. In other words, FIG. 6 is a functional diagram and many of the functions can be combined into one or more pieces of electronic hardware. Further, the actuators may be integrally associated with the vents and latches and valves. In addition, the routine set forth in FIG. 7 is only exemplary in nature. There may be better and more efficient techniques to accomplish the objectives of the present invention and such alternative techniques are also considered within the scope of the invention. The tea basket may also carry batteries to power the electronics and electromechanical controls. Other power supply systems may be utilized such as tapping power from the coffee maker power cord, batteries, etc. In a further enhancement, the controls and display may be located someplace other than on the tea basket and the sensor can transmit their respective information through wireless technology and the valve/actuator receive their command signals also through wireless communication. However, the preferred embodiment is a singular unit with the controls mounted on basket 20.

The present invention is not limited to any particular type of valves or other open/close mechanisms and all that can operate with fluids and high temperatures can be used and are considered within the scope of the invention. Non-limiting examples include spring loaded latches, electromechanical locks or releases and solenoid or magnetic controls. It is also within the scope of the invention to provide sealing devices such as, gaskets, o-rings, washers, etc. where needed to completely seal off wall 26 and the bottom of basket 20 when their associated valves are in a close position.

The claims appended hereto are meant to cover modifications and changes within the scope and spirit of the present invention.

While the invention has been described and disclosed in certain terms and has disclosed certain embodiments or modifications, persons skilled in the art who have acquainted themselves with the invention, will appreciate that it is not necessarily limited by such terms, nor to the specific embodiments and modifications disclosed herein. Thus, a wide variety of alternatives, suggested by the teachings herein, can be practiced without departing from the spirit of the invention, and rights to such alternatives are particularly reserved and considered within the scope of the invention.

What is claimed is:

1. A tea brewing assembly for use with a coffee maker, the coffee maker including a vertical superstructure with an overhanging sub-structure extending therefrom, water reservoir in the superstructure, a heating unit for said water, an upper housing having an internal area for normally receiving a coffee filter assembly, a removable carafe to hold a beverage retained beneath the upper housing, and a water conduit for transferring heated water from said reservoir through said overhanging sub-structure to said upper housing, said tea brewing assembly adapted for disposal within the upper housing and comprising:
a tea brewing basket having an internal area divided by an internal wall into a water receiving section and a tea leaf holding section, said internal wall having a controllable open/close mechanism disposed therein which in an open position permits fluid communication between said water receiving section and said tea leaf holding section and in a close position hydraulically isolates said water receiving section from said tea leaf holding section, said tea brewing basket having a bottom surface, said bottom surface having at least one controllable open/close mechanism disposed therein which in an open position provides fluid communication between the internal area of the tea brewing basket and an upper housing of a coffee maker;
a temperature sensor disposed within said water receiving section;
a tea leaf holder adapted to retain tea leaves therein, said tea leaf holder disposed within said tea leaf holding section;
a user actuatable control to select one or more controls from the group of controls including brew time and brew temperature; and
a controller means, coupled to said user actuatable control, said temperature sensor, said controllable wall open/close mechanism and said controllable bottom surface open/close mechanism for monitoring water temperature, actuating said wall open/close mechanism to an open position at a predetermined temperature to permit heated water within said water receiving section to enter said tea leaf holding section and actuating said bottom surface open/close mechanism after a predetermined brew time has elapsed.

2. The tea brewing assembly of claim 1 further comprising a cover having a top surface and a bottom surface, said cover including a positioner extending downward from said bottom surface, said positioner having a base and a wall member, said base and wall member defining a receiving area for insertion and retention of said tea leaf holder; wherein when said cover is disposed on at least a portion of an upper edge of said tea brewing basket said positioner and said tea leaf holder are disposed within said tea leaf holding section of the internal area of tea brewing basket.

3. The tea brewing assembly of claim 2 wherein said cover covers both said water receiving section and said tea leaf holding section of the internal area.

4. The tea brewing assembly of claim 2 wherein said cover covers said tea leaf holding section of the internal area.

5. The tea brewing assembly of claim 3 wherein said cover having an opening therethrough on a portion aligned with the water receiving section when said cover is in place on the tea brewing basket, wherein the cover opening provides access to the water receiving section for heated water coming from the coffee maker.

6. The tea brewing assembly of claim 2 wherein said user actuatable control disposed within the tea leaf holding section and accessible to the user at an upper portion of the tea leaf holding section, said cover having a cutout having a shape corresponding to the shape of the user actuatable control at the upper portion of the tea leaf holding section.

7. The tea brewing assembly of claim 1 further comprising a high water sensor and a low water sensor to detect water levels in said water receiving section of said tea brewing basket, said high and low water sensors coupled to said controller means for monitoring water level within said water receiving section.

8. The tea brewing assembly of claim 7 wherein said temperature sensor is disposed approximate to said low water sensor.

9. The tea brewing assembly of claim 3 further comprising a controllable air vent near a top of said water receiving section of the tea brewing basket to vent air therefrom, said air vent coupled to said controller means.

10. The tea brewing assembly of claim 1 wherein said tea leaf holder having a length that is equal to at least half of a majority of the height dimension for said tea brewing basket from its bottom surface to its upper edge.

11. The tea brewing assembly of claim 1 wherein an intermediate portion of said tea leaf holder is constructed from a mesh or screen material to provide a plurality of openings to permit heated water to contact tea leaves disposed within the tea leaf holder during a tea brewing period.

12. The tea brewing assembly of claim 9 wherein said controller includes means for controlling said air vent and venting air when the temperature of said heated water exceeds said brew temperature control.

13. A tea brewing assembly for use with a coffee maker, the coffee maker including a vertical superstructure with an overhanging sub-structure extending therefrom, water reservoir in the superstructure, a heating unit for said water, an upper housing having an internal area for normally receiving a coffee filter assembly, a removable carafe to hold a beverage retained beneath the upper housing, and a water conduit for transferring heated water from said reservoir through said overhanging sub-structure to said upper housing, said tea brewing assembly adapted for disposal within the upper housing and comprising:
a tea brewing basket having an internal area divided by an internal wall into a water receiving section and a tea leaf holding section, said internal wall having a controllable open/close mechanism disposed therein which in an open position permits fluid communication between said water receiving section and said tea leaf holding section and in a close position hydraulically isolates said water receiving section from said tea leaf holding section, said tea brewing basket having a bottom surface, said bottom surface having at least one controllable open/close mechanism disposed therein which in an open position provided fluid communication between the internal area of the tea brewing basket and an upper housing of a coffee maker;
a temperature sensor disposed within said water receiving section;
a tea leaf holder adapted to retain tea leaves therein, said tea leaf holder disposed within said tea leaf holding section, said tea leaf holder having an intermediate portion constructed from a mesh or screen material to provide a plurality of openings to permit heated water to contact tea leaves disposed within the tea leaf holder during a tea brewing period;
a user actuatable control to select one or more controls from the group of controls including brew time and brew temperature, said user actuatable control disposed within the tea leaf holding section and accessible to the user at an upper portion of the tea leaf holding section;
a cover having a top surface and a bottom surface, said cover including a positioner extending downward from said bottom surface, said positioner having a base and a wall member, said base and wall member defining a receiving area for insertion and retention of said tea leaf holder; wherein when said cover is disposed on at least a portion of an upper edge of said tea brewing basket said positioner and said tea leaf holder are disposed within said tea leaf holding section of the internal area of tea brewing basket, said cover having a cutout having a shape corresponding to the shape of the user actuatable control at the upper portion of the tea leaf holding section; and
a controller means, coupled to said user actuatable control, said temperature sensor, said controllable wall open/close mechanism and said controllable bottom surface open/close mechanism for monitoring water temperature, actuating said wall open/close mechanism to an open position at a predetermined temperature to permit heated water within said water receiving section to enter said tea leaf holding section and actuating said bottom surface open/close mechanism after a predetermined brew time has elapsed.

14. The tea brewing assembly of claim 13 wherein said cover covers both said water receiving section and said tea leaf holding section of the internal area and having an opening therethrough on a portion aligned with the water receiving section when said cover is in place on the tea brewing basket, wherein the cover opening provides access to the water receiving section for heated water coming from the coffee maker.

15. The tea brewing assembly of claim 13 further comprising a high water sensor and a low water sensor to detect water levels in said water receiving section of said tea brewing basket, said high and low water sensors coupled to said controller means for monitoring water level within said water receiving section, wherein said temperature sensor is disposed approximate to said low water sensor.

16. The tea brewing assembly of claim 14 further comprising a controllable air vent near a top of said water receiving section of the tea brewing basket to vent air therefrom, said air vent coupled to said controller means, wherein said controller includes means for controlling said air vent and venting air when the temperature of said heated water exceeds said brew temperature control

17. The tea brewing assembly of claim 13 wherein said tea leaf holder having a length that is equal to at least half of a majority of the height dimension for said tea brewing basket from its bottom surface to its upper edge.

18. A tea brewing assembly for use with a coffee maker, the coffee maker including a vertical superstructure with an overhanging sub-structure extending therefrom, water reservoir in the superstructure, a heating unit for said water, an upper housing having an internal area for normally receiving a coffee filter assembly, a removable carafe to hold a beverage retained beneath the upper housing, and a water conduit for transferring heated water from said reservoir through said overhanging sub-structure to said upper housing, said tea brewing assembly adapted for disposal within the upper housing and comprising:
a tea brewing basket having an internal area divided by an internal wall into a water receiving section and a tea leaf holding section, said internal wall having a controllable open/close mechanism disposed therein which in an open position permits fluid communication between said water receiving section and said tea leaf holding section and in a close position hydraulically isolates said water receiving section from said tea leaf holding section, said tea brewing basket having a bottom surface, said bottom surface having at least one controllable open/close mechanism disposed therein which in an open position provided fluid communication between the internal area of the tea brewing basket and an upper housing of a coffee maker;
a temperature sensor disposed within said water receiving section;
an elongated tea leaf holder having a substantially cylindrical cross-shape and adapted to retain tea leaves therein, said tea leaf holder disposed within said tea leaf holding section, said tea leaf holder having an intermediate portion constructed from a mesh or screen material to provide a plurality of openings to permit heated water to contact tea leaves disposed within the tea leaf holder during a tea brewing period, said tea leaf holder having a lid member secured to one end of the intermediate portion which is movable from an open position to permit tea leaves to be inserted within said holder to a closed position for retaining the inserted tea leaves;
a user actuatable control to select one or more controls from the group of controls including brew time and brew temperature, said user actuatable control disposed within the tea leaf holding section and accessible to the user at an upper portion of the tea leaf holding section;
a cover having a top surface and a bottom surface, said cover including a positioner extending downward from said bottom surface, said positioner having a base and a wall member, said positioner wall member having a shape corresponding to the shape of said tea leaf holder, said base and wall member defining a receiving area for insertion and retention of said tea leaf holder; wherein when said cover is disposed on at least a portion of an upper edge of said tea brewing basket said positioner and said tea leaf holder are disposed within said tea leaf holding section of the internal area of tea brewing basket, said cover having a cutout having a shape corresponding to the shape of the user actuatable control at the upper portion of the tea leaf holding section, said cover covering both said water receiving section and said tea leaf holding section of the internal area and having an opening therethrough on a portion aligned with the water receiving section when said cover is in place on the tea brewing basket, wherein the cover opening provides access to the water receiving section for heated water coming from the coffee maker; and
a controller means, coupled to said user actuatable control, said temperature sensor, said controllable wall open/close mechanism and said controllable bottom surface open/close mechanism for monitoring water temperature, actuating said wall open/close mechanism to an open position at a predetermined temperature to permit heated water within said water receiving section to enter said tea leaf holding section and actuating said bottom surface open/close mechanism after a predetermined brew time has elapsed.

19. The tea brewing assembly of claim 18 further comprising a high water sensor and a low water sensor to detect water levels in said water receiving section of said tea brewing basket, said high and low water sensors coupled to said controller means for monitoring water level within said water receiving section, wherein said temperature sensor is disposed approximate to said low water sensor.

20. The tea brewing assembly of claim 18 further comprising a controllable air vent near a top of said water receiving section of the tea brewing basket to vent air therefrom, said air vent coupled to said controller means, wherein said controller includes means for controlling said air vent and venting air when the temperature of said heated water exceeds said brew temperature control

21. The tea brewing assembly of claim 18 wherein said tea leaf holder having a length that is equal to at least half of a majority of the height dimension for said tea brewing basket from its bottom surface to its upper edge.
